(19) United States
(12) Patent Application Publication
(10) Pub. No.: US 2024/0175159 A1
(43) Pub. Date: May 30, 2024

(54) POSITIONING SYSTEM FOR A LIFTING APPARATUS AND METHOD OF USE

(71) Applicant: ALUMATIQ AS, Mosjøen (NO)

(72) Inventors: Frode Breimo, Mosjoen (NO); Thomas Sperle, Trondheim (NO); Johan Moflag, Mo l Rana (NO); Jan-Hugo Lynghei, Mo l Rana (NO)

(21) Appl. No.: 18/284,582

(22) PCT Filed: Mar. 31, 2022
(86) PCT No.: PCT/EP2022/058730

§ 371 Date: Sep. 28, 2023

(30) Foreign Application Priority Data
Mar. 31, 2021 (GB) 2104618.0

(51) Int. Cl. C25C 3/10; B66C 9/14; B66C 13/46; B66C 17/06; C25C 7/06

(52) U.S. Cl. CPC C25C 3/10; B66C 9/14; B66C 13/46; B66C 17/06; C25C 7/06

(57) ABSTRACT

The invention provides a positioning system for a lifting apparatus. The positioning system comprises a movable support having a longitudinal axis. The system comprises a first positioning member movably mounted to the support, wherein the first positioning member comprises a first axis and a second axis and is configured to move along the longitudinal axis of the support with the first axis parallel to the longitudinal axis of the support. The system also comprises a second positioning member mounted to the first positioning member and configured to move transversely to the first axis of the first positioning member.

The present invention relates to a positioning system for a lifting apparatus and a method of use, and particular aspects relate to positioning lifting and handling equipment for heavy payloads such as anode replacement equipment. Aspects of the invention relate to a crane system incorporating the positioning apparatus and method of use.

### BACKGROUND TO THE INVENTION

In many industries including shipping, construction, manufacturing and production industries lifting systems such as cranes are used to lift, handle, move heavy loads and/or position pieces of equipment.

Industrial cranes are large, bulky and heavy requiring a skilled operator to manoeuvre the crane and its attached load or piece of equipment. If the crane is a travelling crane the operator must control the movement of the crane as it travels along its rails in addition to operating a trolley supporting the load or piece of equipment as it moves along the length of the crane beam.

In order to the engage a load or position a piece of equipment for an operation task the operator must accurately control the position of the trolley. The crane operator must depend on visibility of the work environment, the load or piece of equipment, personnel in the vicinity and the planned travel path of the suspended load or equipment.

During connection and disconnection of a load or operation of a suspended piece of equipment ground personnel are required to be in close proximity to the heavy object. Accidents may occur during lifting, handling and/or movement of the suspended load or equipment. For example, during connection of a load to a lifting apparatus and load lifting, ground personnel are required to physically connect the load to the crane apparatus. If the load engaging means is not correctly aligned with the load, then upon lifting the heavy load can swing uncontrollably and pose a threat to nearby personal and infrastructure. Disconnection of the load from the crane can be dangerous if the suspended load is not aligned or in the correct orientation as it is being lowered and disconnected from the lifting apparatus.

If a lifting apparatus and suspended piece of equipment is not correctly aligned with a work object then the suspended equipment may be put under stress and result in damage to the equipment, work object and/or nearby personnel.

Handling a heavy suspended load or piece of equipment can involve personnel manually pulling guide ropes connected to the suspended load or equipment in order to orientate it into a correct position and around obstacles. There is a high risk of serious injury or death if a suspended load or piece of equipment should fall or have an impact during handling operations. The level of danger increases if the crane operator does not have good visibility of the work environment, the movement path of the crane or if the ground personnel are distracted and focused on the suspended load/equipment rather than potential obstacles or their dangerous surroundings.

During each of these operations the view of a crane operator may become obscured by obstacles in the work environment, or an operator may lose track of personnel in close proximity to a suspended heavy load or equipment.

Moving a bulky crane to correctly align a load engaging means with a load or correctly align a piece of equipment with a work object can be time consuming and dangerous if there is miscommunication between the crane operator and ground personnel.

### SUMMARY OF THE INVENTION

There is generally a need for a positioning system for a lifting apparatus which addresses one or more of the problems identified above.

It is an object of an aspect of the present invention to provide a lifting apparatus and method of use which obviates or mitigates one or more drawbacks or disadvantages of the prior art.

It is another object of at least one aspect of the present invention to provide a positioning system for a lifting apparatus for accurate handling and positioning of equipment or heavy payloads.

It is a further object of an aspect of the present invention to provide a robust, reliable, sturdy positioning system suitable for mounting on lifting apparatus for deployment in a wide range of lifting applications.

It is another object of an aspect of the present invention to provide a positioning system for an anode replacement system for accurate handling and positioning of equipment to remove spent anodes and accurately position replacement anodes.

Further aims and objects of the invention will become apparent from reading the following description.

According to a first aspect of the invention, there is provided a positioning system; the positioning system comprising:
a support;
a positioning member movably mounted on or to the support, and
at least one motor configured to move the positioning member along a longitudinal axis of the support.

The positioning system is preferably for a lifting apparatus. The positioning system may be for an anode replacement system. The positioning system may be configured to accurately position and/or move an anode replacement system or at least one component of an anode replacement system. The lifting apparatus may be or may be part of an anode replacement system. The support may be a movable support. The positioning member may comprise a first axis and a second axis. The positioning member may be configured to move along the longitudinal axis of the support with the first axis or second axis parallel to the longitudinal axis of the support. The positioning system may comprise a second positioning member movably mounted to the first positioning member. The second positioning member may be configured to move transversely to the first axis of the first positioning member. The second positioning member may be configured to move transversely to the longitudinal axis of the support. The support may be configured to move in a direction substantially parallel with the second axis of the first positioning member. The first positioning member and the second positioning member may be configured to move independently of one another, or together. The first positioning member may be a first trolley. The second positioning member may be a second trolley.

The positioning system may comprise a plurality of motors. The positioning system may comprise at least one motor configured to move the support. The positioning system may comprise at least one motor configured to move the first positioning member along or relative to the support. The positioning system may comprise at least one motor configured to move the second positioning member along the first positioning member. The positioning system may comprise at least one motor configured to move the second positioning member move transversely to the first axis of the first positioning member. At least one motor may be configured to move the support, first positioning member and/or second positioning member within an accuracy of between 0.5 mm to 10 mm. At least one motor may be configured to move the support, first positioning member and/or second positioning member within an accuracy of between 1 mm to 5 mm. At least one motor may be configured to move the support, first positioning member and/or second positioning member within an accuracy +/−1 mm.

The at least one motor may be a servomotor. The positioning system may comprise a plurality of motors configured to move the support, first positioning member and/or second positioning member. An anode replacement system or components of an anode replacement system may be connected to the first and/or second positioning member.

According to a second aspect of the invention, there is provided a method of positioning an anode replacement system, the method comprising providing a positioning system, the positioning system comprising:
a support;
a positioning member movably mounted to the support, and
at least one motor;
moving the positioning member along a longitudinal axis of the support.

The support may be a movable support. The support may be configured to be mounted on a crane or vehicle. The first positioning member may comprise a first axis and a second axis.

The method may comprise moving the first positioning member along the longitudinal axis of the support with the first axis parallel to the longitudinal axis of the support. The positioning system may comprise a second positioning member movably mounted to the first positioning member. The method may comprise moving the second positioning member in a direction substantially transverse to the first axis of the first positioning member. The method may comprise moving the second positioning member in a direction substantially transverse to the longitudinal axis of the support. The method may comprise moving the support in a direction substantially parallel with the second axis of the first positioning member. The method may comprise moving the first positioning member and the second positioning member independently of one another, or together. The first positioning member may be a first trolley. The second positioning member may be a second trolley.

At least one motor may be configured to move the support, first positioning member and/or second positioning member. The at least one motor may be a servomotor. The method may comprise moving the support, first positioning member and/or second positioning member within an accuracy of between 0.5 mm to 10 mm. The method may comprise moving the support, first positioning member and/or second positioning member within an accuracy of between 1 mm to 5 mm. The method may comprise moving the support, first positioning member and/or second positioning member within an accuracy of +/−1 mm.

Embodiments of the second aspect of the invention may include one or more features of the first aspect of the invention or its embodiments, or vice versa.

According to a third aspect of the invention, there is provided a positioning system; the positioning system comprising:
a support having a longitudinal axis;
a first positioning member movably mounted to the support, wherein the first positioning member comprises a first axis and a second axis, and is configured to move along the longitudinal axis of the support with the first axis parallel to the longitudinal axis of the support;
a second positioning member movably mounted to the first positioning member and configured to move transversely to the first axis of the first positioning member.

The positioning system may be for an anode replacement system. The positioning system may be configured to accurately position and/or move an anode replacement system or at least one component of an anode replacement system. The positioning system may be connected to the first or second positioning member.

The second positioning member may be configured to move along a longitudinal axis of the first positioning member. The second positioning member may be configured to move substantially perpendicularly to the first axis of the first positioning member, which may be the second axis of the first positioning member. The second positioning member may therefore be configured to move transversely to the longitudinal axis of the support.

The first positioning member may be configured to move along the longitudinal axis of the support by one or more mechanisms configured to slide, push and/or pull the first positioning member. The second position member may be configured to move transversely to the first axis of the first positioning member by one or more mechanisms configured to slide, push and/or pull the second positioning member.

The support may be a movable support. The support may be configured to move in a direction substantially parallel with the second axis of the first positioning member. The support may be or form a bridge crane.

The first positioning member and the second positioning member may be configured to move independently of one another, or together. The first positioning member may be a first trolley. The second positioning member may be a second trolley.

The support may comprise at least one rail or track. The first positioning member may be configured to transfer forces acting on the first positioning member to the support. The first positioning member may comprise a plurality of wheels, pinions, or rollers. The plurality of wheels, pinions or rollers may be configured to engage or contact a guide track or rail of the support. The plurality of wheels, pinions or rollers may be configured to be moveable along a guide track or rail on the support to move the first positioning member along the longitudinal axis of the support. The first positioning member may comprise a screw or screw rod.

The first positioning member may comprise at least one rail or track. The second positioning member may comprise a plurality of wheels, pinons, or rollers. The plurality of wheels, pinons, or rollers on the second positioning member may be configured to engage or contact a guide track or rail on the first positioning member. The plurality of wheels, pinons or rollers may be configured to be moveable along the guide track or rail on the first positioning member to move the second positioning member transversely to the first axis.

The second positioning member may be configured to transfer forces acting on the second positioning member to the first positioning member.

The positioning system may comprise at least one drive mechanism. The at least one drive mechanism may comprise at least one rack and pinion drive mechanism. The positioning system may comprise a first drive mechanism for the first positioning member and may comprise a second drive mechanism for the second positioning member. The at least one drive mechanism may comprise at least one drive means.

The at least one drive means may be configured to move the support, the first positioning member and/or the second positioning member. The at least one drive means may be hydraulic, pneumatic and/or electric system. The at least one drive means may be a combination of hydraulic, pneumatic and/or electric systems. The at least one drive means may comprise one or more motors configured to move the support, first positioning member and/or second positioning member. The one or more motors may comprise one or more electric motors. The one or more motors may comprise one or more servomotors.

The system may comprise a control unit configured to control the position and/or movement of the support, first positioning member and/or second positioning member. The control unit may be configured accurately control the position and/or movement of the support, first trolley and second trolley to within a range of 0.5 mm to 10 mm. The control unit may be configured accurately control the position and/or movement of the support, first trolley and second trolley to 1 mm.

The first axis of the first positioning member may be a longitudinal axis of the first positioning member, and/or is preferably transverse or substantially perpendicular to the longitudinal axis of the support.

The first positioning member may be configured to move in a horizontal plane. The second positioning member may be configured to move in a horizontal plane. The support may be configured to move in a horizontal plane and/or a vertical axis perpendicular to the horizontal plane.

The support may be configured to move rapidly in a horizontal and/or vertical plane to locate the first positioning member and the second positioning member at a desired location. The first positioning member and/or the second position may be moved in a horizontal plane with more precision to accurately locate the lifting apparatus.

The positioning of the support may not be required to be a precise movement and may have a high degree of tolerance as its purpose may be to locate the first positioning member and the second positioning member within a general proximity of a desired location of a load or object. The drive system for the support may be optimised for efficient and rapid movement allowing the support to travel across a work environment quickly and transport the first positioning member and the second positioning member with a first level of position control. The positioning of the support may be performed quickly and safely. By locating the support at a general location rather than a precise location the operator may not be preoccupied with locating the support with a high degree of accuracy and may be able to concentrate on potential obstacles in the support movement path.

The drive system of the first positioning member and/or second positioning member may be configured or optimised for accurate positional control to bring the lifting apparatus and attached equipment such as an anode replacement system to the desired location once the support is positioned in the general proximity of a desired location.

The support, first positioning member and/or a second positioning member may comprise a plurality of positional markers. The plurality of positional markers may be arranged along the longitudinal length of the support, first positioning member and/or a second positioning member. The plurality of positional markers may be selected from the group comprising: barcodes, data matrix codes, quick response codes and/or colour codes.

The system may comprise a sensor system. The sensor system may be configured to detect, monitor and/or control the position of the support, first positioning member and/or the second positioning member. The sensor system may be configured to detect at least one of the plurality of positional markers to accurately locate and/or move the position of the support, first positioning member and/or a second positioning member.

The sensor system may be configured to generate 2D and/or 3D position information of the positioning system, the support, the first positioning member, the second positioning member, a suspended or supported load, a suspended or supported piece of equipment and/or a work environment. The sensor system may be configured to generate 2D and/or 3D position information of components of the positioning system, the support, the first positioning member, the second positioning member, a suspended or supported load and/or a suspended or supported piece of equipment in relation to each other and/or to the work environment. The sensor system may be configured to generate 2D and/or 3D position information of potential obstacles in the work environment. The sensor system may be configured to generate 2D and/or 3D position information of personnel in the work environment.

The sensor system may be configured to generate position information to identify at least one object in the work environment to position a piece of equipment to perform one or more tasks on or with the object. The sensor system may be configured to generate position information to identify a load in the work environment to position a lifting equipment to lift the load.

The sensor system may be configured to communicate the position information to at least one processing unit. The at least one processing unit may be configured to process a movement path for the positioning system, the support, the first positioning member, the second positioning member, a suspended or supported load and/or a suspended or supported piece of equipment based on the position information generated by the sensor system. The sensor system may be configured to monitor the positional information to prevent a collision in the work environment.

The sensor system may comprise at least one sensor. The at least one sensor may be selected from the group comprising: optical sensor, camera, vision system, time of flight camera, depth sensor, distance sensor, laser, ultrasound, momentum sensor, accelerometer, rotary position sensors, gyroscopic position sensor, global positioning sensor, infra-red sensor, thermal sensor, load cell and/or LIDAR.

The control system may be configured to control the movement of the support based on the data from the sensor system. The control system may be configured to control the movement of the first positioning member along the longitudinal axis of the support based on the data from the sensor system. The control system may be configured to control the movement of the second positioning member along the longitudinal axis of the first positioning member based on the data from the sensor system.

The support, first positioning member and/or the second positioning member may support a load and/or equipment. The support, first positioning member and/or the second positioning member may comprise a platform configured to suspend and/or support a piece of equipment. Preferably the second positioning member comprises a rotatable platform. The platform may be a rotatable platform. A load or a piece of equipment may be suspended from, connected to, or mounted on the rotatable platform. The control system may be configured to control the movement of the platform based on data from the sensor system. The control system may be configured to control the rotational movement of the platform based on data from the sensor system.

A load or a piece of equipment may be suspended from, connected to, or mounted on the rotatable platform by one or more springs. The load or a piece of equipment may be suspended from, connected to, or mounted on the rotatable platform by a spring suspension system. The spring suspension system may comprise one or more rigid or stiff springs. The spring suspension system may comprise one or more shock absorbers. The spring suspension system may be configured to minimise or mitigate forces acting on the load or a piece of equipment being transferred to the rotatable platform and/or components of the positioning system. The spring suspension system may be configured to minimise or mitigate forces acting on the rotatable platform and/or components of the positioning system being transferred to the load or a piece of equipment.

The piece of equipment may comprise a robot assembly, a lifting system and/or a pulley system. The piece of equipment may comprise an anode replacement system or at least one component of an anode replacement system. The sensor system may be configured to control the position and movement of the piece of equipment.

The support may be a component of a crane or vehicle. The support may be a component of a crane mounted vehicle. The support may be a movable support. The support may be at least one rail or track of a crane or vehicle. The positioning system may be configured to be connected to a lifting apparatus. The positioning system may be configured to be connected to a crane. The positioning system may be configured to be connected to a vehicle. The sensor system may be configured to detect, monitor and/or control the position of lifting apparatus, crane, or vehicle to which the positioning system is connected. The support, first positioning member and/or the second positioning member may be configured to support a load and/or a piece of equipment.

The sensor system may comprise a vision system. The vision system may be configured to obtain accurate positional data on a suspended or supported load and/or a suspended or supported piece of equipment. The vision system may be configured to generate 2D and/or 3D position information of a piece of equipment in relation to a work environment. The vision system may comprise at least one sensor. The vision system may comprise at least one optical sensor, camera, time of flight camera, depth sensor, distance sensor and/or laser. Preferably, the vision system comprises at least one time of flight camera. The vision system may provide real time images and/or distance information between the camera and the subject for each point of a captured image.

The control system may be configured to control the movement of a suspended or supported load and/or a suspended or supported piece of equipment based on the data from the vision system of the sensor system. The control system may be configured to control the movement of the support, first positioning member, second positioning member and/or the rotatable platform based on the data from the vision system of the sensor system.

The system may be an autonomous system or a semi-autonomous system. The system may be an automated system or a semi-automated system. The system may be controlled by a user controlling remote manipulators.

Embodiments of the third aspect of the invention may include one or more features of any of the first or second aspects of the invention or their embodiments, or vice versa.

According to a fourth aspect of the invention, there is provided a positioning system for a lifting apparatus; the positioning system comprising:
a support having a longitudinal axis;
a first trolley movably mounted to the support, wherein the first trolley comprises a first axis and a second axis, and is configured to move along the longitudinal axis of the support with the first axis parallel to the longitudinal axis of the support;
a second trolley movably mounted to the first trolley and configured to move transversely to the first axis of the first trolley.

The second trolley may be configured to move substantially perpendicularly to the first axis of the first trolley, which may be the second axis of the first trolley. The second trolley may therefore be configured to move transversely to the longitudinal axis of the support.

Embodiments of the fourth aspect of the invention may include one or more features of the first to third aspects of the invention or their embodiments, or vice versa.

According to a fifth aspect of the invention, there is provided a positioning system for locating a functional device to perform a task, the positioning system comprising:
a support;
a first positioning member movably mounted to the support, wherein the first positioning member comprises a first axis and a second axis, and is configured to move along the longitudinal axis of the support with the first axis parallel to the longitudinal axis of the support;
a second positioning member movably mounted to the first positioning member and configured to move transversely to the first axis of the first positioning member.

The second positioning member may be configured to move substantially perpendicularly to the first axis of the first positioning member, which may be the second axis of the first positioning member. The second positioning member may therefore be configured to move transversely to the longitudinal axis of the support.

The first positioning member may be configured to move along the longitudinal axis of the support by one or more mechanisms configured to slide, push and/or pull the first positioning member. The second position member may be configured to move transversely to the first axis of the first positioning member by one or more mechanisms configured to slide, push and/or pull the second positioning member.

The first positioning member may be a first trolley. The second positioning member may be a second trolley.

The system may comprise a support drive mechanism configured to move the support. The system may comprise a first positioning member drive mechanism configured to move the first positioning member along a first axis relative to the support. The system may comprise a second positioning member drive mechanism configured to move the second positioning member along the second axis.

The functional device may be mounted to the support, first positioning member or second positioning member. The functional device may be movably mounted to the support, first positioning member or second positioning member. Preferably the functional device is movably mounted to the second positioning member. The functional device may be rotationally mounted to the second positioning member. The system may comprise a rotational drive mechanism to rotate the position of the functional device relative to the second positioning member. The functional device may be an anode replacement system or at least one component of an anode replacement system.

The support, first and/or second drive mechanisms may each include at least one motor. The support may be a component of a crane or vehicle. The support may be a component of a crane mounted vehicle. The support may be a movable support. The support may be at least one rail or track of a crane or vehicle.

The sensor system may comprise at least one sensor. The at least one sensor may be selected from the group comprising: optical sensor, camera, vision system, time of flight camera, depth sensor, distance sensor, laser, ultrasound, momentum sensor, accelerometer, rotary position sensors, gyroscopic position sensor, global positioning sensor, infra-red sensor, thermal sensor, load cell and/or LIDAR.

The at least one sensor configured to detect, monitor, and/or measure movement of the support. The sensor system may comprise at least one sensor configured to detect, monitor and/or measure movement of the first positioning member. The sensor system may comprise at least one sensor configured to detect, monitor and/or measure movement of the second positioning member. The at least one sensor may be mounted on a component of the positioning system. The at least one sensor may be mounted on the support, first positioning member and/or second positioning member. The at least one sensor may be mounted on a component of a crane, vehicle, or structure. The at least one sensor may be mounted on at least one part of a structure such as a roof, floor and/or wall. The vision system of the sensor system may comprise at least one sensor configured to detect, monitor, and/or measure the movement of a load or equipment connected to the second positioning member.

The at least one sensor may be mounted on the support, first positioning member, second positioning member, load and/or equipment.

The system may comprise at least one processing unit. The system may comprise at least one control unit. The at least one processing unit may be configured to process data received from the sensor system. The at least one control unit may be configured to control the position of the support, first positioning member and/or second positioning member. The at least one control unit may be configured to control the actuation of the support drive mechanism, first positioning member drive mechanism and/or second positioning member drive mechanism.

Embodiments of the fifth aspect of the invention may include one or more features of the first to fourth aspects of the invention or their embodiments, or vice versa.

According to a sixth aspect of the invention, there is provided a positioning system for a crane, the positioning system comprising:
at least one support connected to the crane;
a first positioning member movably mounted to the support, wherein the first positioning member comprises a first axis and a second axis, and is configured to move along the longitudinal axis of the support with the first axis parallel to the longitudinal axis of the support;
a second positioning member movably mounted to the first positioning member and configured to move transversely to the first axis of the first positioning member.

An anode replacement system or at least one component of an anode replacement system may be connected to the first and/or the second positioning member.

Embodiments of the sixth aspect of the invention may include one or more features of any of the first to fifth aspects of the invention or their embodiments, or vice versa.

According to a seventh aspect of the invention, there is provided a lifting apparatus; the lifting apparatus comprising:
a positioning system comprising:
a support;
a first positioning member movably mounted to the support, wherein the first positioning member comprises a first axis and a second axis, and is configured to move along the longitudinal axis of the support with the first axis parallel to the longitudinal axis of the support;
a second positioning member movably mounted to the first positioning member and configured to move transversely to the first axis of the first positioning member.

The lifting apparatus may be a crane or vehicle. The support may be a component of a crane or vehicle.

Embodiments of the seventh aspect of the invention may include one or more features of any of the first to sixth aspects of the invention or their embodiments, or vice versa.

According to an eighth aspect of the invention, there is provided a crane; the crane comprising a positioning system;
the positioning system comprising:
a first positioning member movably connected to a crane bridge, wherein the first positioning member comprises a first axis and a second axis, and is configured to move along a longitudinal axis of the crane bridge with the first axis parallel to the longitudinal axis of the crane bridge;
a second positioning member movably mounted to the first positioning member and configured to move transversely to the first axis of the first positioning member.

Embodiments of the eighth aspect of the invention may include one or more features of any of the first to seventh aspects of the invention or their embodiments, or vice versa.

According to a ninth aspect of the invention, there is provided a method of positioning a load or piece of equipment, the method comprising providing a positioning system, the positioning system comprising:
a support having a longitudinal axis;
a first positioning member movably mounted to the support, wherein the first positioning member comprises a first axis and a second axis;
a second positioning member connected to a load or piece of equipment;
the second positioning member movably mounted to the first positioning member;
moving the first positioning member along the longitudinal axis of the support; and
moving the second positioning member transversely to the first axis of the first positioning member.

The method may comprise moving the first positioning member along the longitudinal axis of the support with the first axis parallel to the longitudinal axis of the support. The method may comprise moving the positioning system in a direction substantially parallel with the second axis to a first position accuracy. The method may comprise moving the support in a direction substantially parallel with the second axis to a first position accuracy.

The method may comprise moving the first positioning member along the longitudinal axis of the support with the first axis parallel to the longitudinal axis of the support.

The method may comprise moving the second positioning member in a direction substantially parallel with the second axis to locate the load or piece of equipment to a second position accuracy. The second position accuracy may be higher than the first position accuracy.

The method may comprise moving a crane and/or vehicle which comprises the support. The method may comprise moving a crane and/or vehicle which is connected to the support. The method may comprise detecting and/or tracking the position of the support, crane and/or vehicle to accurately locate and/or calculate the position of positioning system. The method may comprise detecting and/or tracking the position of the support, crane and/or vehicle to accurately locate and/or move the position of positioning system. The method may comprise detecting at least one positional marker to accurately locate and/or move the position of positioning system. The method may comprise detecting at least one positional marker on a crane or vehicle on which the positioning system is movably mounted to accurately locate and/or move the position of positioning system.

The method may comprise detecting at least one positional marker on the support to accurately locate and/or move the position of first positioning member. The method may comprise detecting at least one positional marker on the first positioning member to accurately locate and/or move the position of second positioning member.

The method may comprise moving the support, first positioning member and/or a second positioning member to align with at least a second position positional marker to accurately relocate the position of a load or piece of equipment.

The method may comprise obtaining accurate positional data of a suspended or supported load and/or a suspended or supported piece of equipment using a sensor system.

Embodiments of the ninth aspect of the invention may include one or more features of any of the first to eighth aspects of the invention or their embodiments, or vice versa.

According to a tenth aspect of the invention, there is provided a method of positioning and/or moving a piece of equipment, the method comprising;
providing a positioning system, the positioning system comprising
a support;
a first positioning member movably mounted to the support;
second positioning member movably mounted to the first positioning member; wherein the piece of equipment is connected to the second positioning member;
moving the support along a first axis to locate the piece of equipment to a first position accuracy;
moving the second positioning member along the first positioning member in a direction substantially parallel to the first axis to locate the piece of equipment to a second position accuracy; wherein the second position accuracy is higher than the first position accuracy.

The movement axis of the support and the movement axis of the second positioning member may be substantially parallel. The method may comprise moving the first positioning member direction substantially transverse to the first axis.

Embodiments of the tenth aspect of the invention may include one or more features of any of the first to ninth aspects of the invention or their embodiments, or vice versa.

According to an eleventh aspect of the invention, there is provided a method of positioning and/or moving a piece of equipment, the method comprising;
providing a positioning system, the positioning system comprising
a support having a longitudinal axis;
a first positioning member movably mounted to the support;
second positioning member movably mounted to the first positioning member; wherein the piece of equipment is connected to the second positioning member;
moving the second positioning member along the first positioning member to locate the piece of equipment to a desired position.

The method may comprise moving the second positioning member along a longitudinal axis of the first positioning member. The method may comprise moving the first positioning member along a longitudinal axis of the support.

The first positioning member may comprise a first axis and a second axis. The method may comprise moving the first positioning member along the longitudinal axis of the support with the first axis parallel to the longitudinal axis of the support. The method may comprise moving second positioning member transversely to the first axis of the first positioning member.

Embodiments of the eleventh aspect of the invention may include one or more features of any of the first to tenth aspects of the invention or their embodiments, or vice versa.

According to a twelfth aspect of the invention, there is provided a positioning system for a lifting apparatus; the position system comprising:
a support;
a first positioning member movably mounted on the support and configured to move along a longitudinal axis of the support;
a second positioning member movably mounted to the first positioning member and configured to move along a longitudinal axis of the first positioning member;
wherein the longitudinal axis of the support is substantially perpendicular to the longitudinal axis of the first positioning member.

Embodiments of the twelfth aspect of the invention may include one or more features of any of the first to eleventh aspect of the invention or their embodiments, or vice versa.

According to a thirteenth aspect of the invention, there is provided a method of replacing an anode assembly in an aluminium production process;
the method comprising:
providing an anode replacement system comprising at least one anode gripping apparatus; and
a positioning system for the anode replacement system;
the positioning system comprising;
a support
a first positioning member movably mounted to the support, wherein the first positioning member comprises a first axis and a second axis;
a second positioning member connected to the anode replacement system;
the second positioning member movably mounted to the first positioning member;
moving the first positioning member and/or moving the second positioning member to locate the anode replacement system to replace at least one anode of an electrolytic cell.

The method may comprise moving the first positioning member along the longitudinal axis of the support. The method may comprise moving the first positioning member along the longitudinal axis of the support with the first axis parallel to the longitudinal axis of the support. The method may comprise moving the second positioning member transversely to the first axis of the first positioning member.

The method may comprise moving the positioning system in a direction substantially parallel with the second axis to a first position accuracy. The method may comprise moving the support in a direction substantially parallel with the second axis to a first position accuracy.

The method may comprise moving the second positioning member in a direction substantially parallel with the second axis to locate the anode replacement system to a second position accuracy. The second position accuracy may be higher than the first position accuracy.

The method may comprise obtaining accurate positional data of the anode replacement system or at least one component of the anode replacement system using a sensor system.

Embodiments of the thirteenth aspect of the invention may include one or more features of any of the first to twelfth aspects of the invention or their embodiments, or vice versa.

According to a fourteenth aspect of the invention, there is provided a positioning system for a lifting apparatus; the position system comprising:
a support having a longitudinal axis;
a first positioning member movably mounted to the support, wherein the first positioning member comprises a first axis and a second axis, and is configured to move along the longitudinal axis of the support with the first axis parallel to the longitudinal axis of the support;
a second positioning member mounted to the first positioning member and configured to move transversely to the first axis of the first positioning member; and
a sensor system;
wherein the support and the first positioning member comprise a plurality of positional markers;
wherein the sensor system is operable to detect at least one positional marker to generate position information to control the position of the support, first positioning member and/or second positioning member.

The sensor system may comprise at least one sensor. The at least one sensor may be selected from the group of: optical sensor, camera, vision system, time of flight camera, depth sensor, distance sensor, laser, ultrasound, momentum sensor, accelerometer, rotary position sensors, gyroscopic position sensor, global positioning sensor, infra-red sensor, thermal sensor, load cell and/or LIDAR.

Embodiments of the fourteenth aspect of the invention may include one or more features of any of the first to thirteenth aspects of the invention or their embodiments, or vice versa.

### BRIEF DESCRIPTION OF THE DRAWINGS

There will now be described, by way of example only, various embodiments of the invention with reference to the drawings, of which:

FIGS. 1A and 1B are top plan and perspective views of a positioning apparatus for a lifting apparatus in accordance with an embodiment of the present invention;

FIG. 1C is a cross sectional view A-A of the positioning apparatus of FIG. 1A;

FIG. 1D is a cross sectional view B-B of the positioning apparatus of FIG. 1A;

FIGS. 2A to 2D show top plan views of the positioning apparatus of FIG. 1A with the first trolley and second trolley located at various positions.

FIGS. 3A and 3B show perspective and top plan views of a positioning apparatus in accordance with an embodiment of the present invention movably mounted on a crane;

FIGS. 4A and 4B show perspective and sectional views of a positioning apparatus and attached piece of equipment in accordance with an embodiment of the present invention; and

FIG. 5 is a schematic diagram of a sensor, processing, and control system for the operation of a positioning apparatus of FIG. 3A in an anode handling operation.

FIGS. 6A and 6B are front and rear perspective views of a positioning apparatus for an anode replacement system in accordance with an embodiment of the present invention;

FIG. 6C is an enlarged view of the wheels of the crane bridge of the positioning apparatus of FIG. 6A mounted on runway beams.

FIG. 6D is an enlarged view of the positioning apparatus of FIG. 6A showing components of the anode replacement system connected to the positioning apparatus.

### DETAILED DESCRIPTION OF PREFERRED EMBODIMENTS

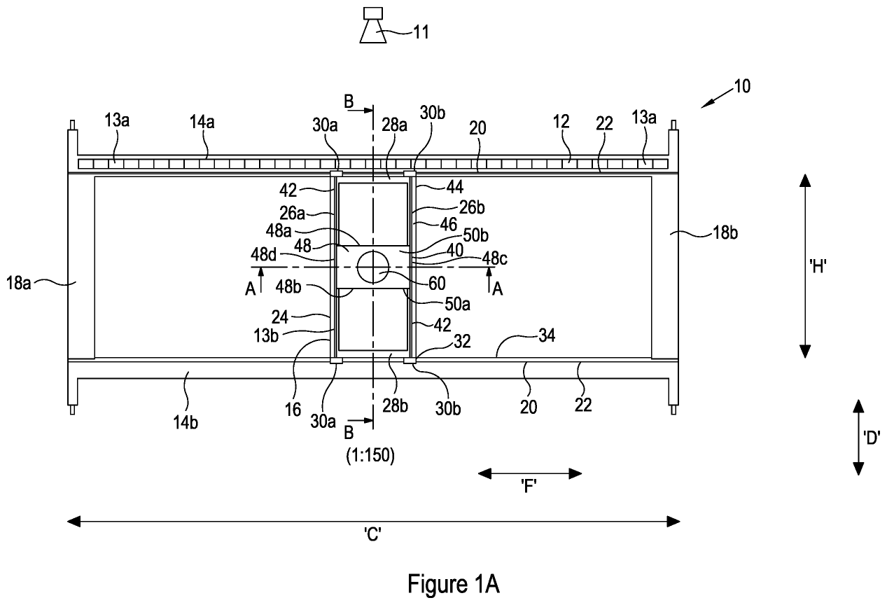

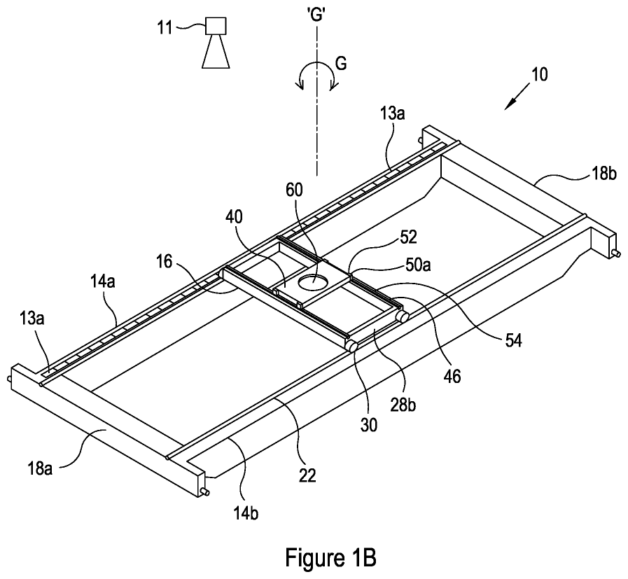

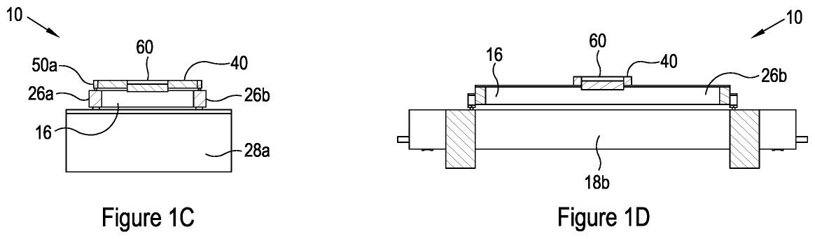

FIGS. 1A and 1B are top plan and perspective views of a positioning system for a lifting apparatus according to an embodiment of the invention. In this example the lifting apparatus is an anode replacement system. The positioning system 10 has a frame 12 comprising two support beams 14a, 14b which are substantially parallel to each other on which a trolley 16 is movably mounted relative to the support beams 14a, 14b. In this example the frame has cross beams 18a, 18b at each end of the support beams 14a, 14b. However, it will be appreciated that the cross beams 18a, 18b may not be required in other embodiments such if the support beams 14a, 14b are secured to component of a crane or vehicle component. It will be appreciated that the frame 12 and/or the support beams 14a, 14b may be movable mounted.

Each of the support beams 14a, 14b has a longitudinal guide 20 located on an upper surface of the support beams 14a, 14b. The longitudinal guide 20 spans the longitudinal length of the support beam, denoted “C” in FIG. 1A. In this example the longitudinal guide 20 is a rack 22. A plurality of positional markers 13a is arranged at known positions along the longitudinal length of the support beam 14a. A camera system 11 mounted above the positioning system captures image data of the positional markers to accurately locate the position of the trolley 16 along the longitudinal length of the support beam 14a. In this example the positional markers are QR (Quick Response) codes 13a.

The trolley 16 has a trolley frame 24 comprising two supports 26a, 26b and two drive supports 28a, 28b. The two drive supports 28a, 28b are connected to the supports 26a 26b as end supports with the drive supports 28a, 28b arranged substantially parallel with the frame support beams 14a, 14b.

The two supports 26a, 26b span the distance between the parallel support beams 14a, 14b. Each of the two drive supports 28a, 28b have two pinion gears 30a, 30b at each end. The pinion gears 30a, 30b are rotatably mounted on the drive supports 28a, 28b. The trolley frame 24 supports reversible motors (not shown) connected to pinion gears 30a. Each pinion gear 30a, 30b has teeth 32 which cooperate with teeth 34 on the rack 22 such that when the motor rotates the pinions 30a, 30b travel along the rack which moves the trolley 16 along the support beams 14a, 14b shown as arrow “F” in FIG. 1A. The pinion gears 30a, 30b support the weight of the trolley 16 and assist in transferring loads or forces acting on the trolley 16 to the support beams 14a, 14b of the lifting apparatus 10.

The motors are connected to a control unit (not shown) to allow the accurate movement of the trolley 16 along the support beams 14a, 14b. The control unit is configured to allow remote and/or automated movement of the trolley.

The trolley 16 supports a movable second trolley 40 as best shown in FIGS. 1C and 1D. Each of the supports 26a, 26b of the trolley frame 24 has a longitudinal guide 42 located on an upper surface 44 of the support beams 26a, 26b. The longitudinal guide 42 spans the longitudinal length of the supports 26a, 26b, denoted as “H” in FIG. 1A. In this example the longitudinal guide 42 is a rack 46. A plurality of positional markers 13b is arranged at known positions along the longitudinal length of a support beam 26a. The camera system 11 captures images of the positional markers to accurately locate the position of the second trolley 40 along the longitudinal length of the support beam 26a, 26b. In this example the positional markers are QR codes 13b.

The second trolley 40 has a base 48 made of steel plate with edges 48a, 48b, 48c and 48d. Opposing edges 48a and 48b span the distance between the substantially parallel supports 26a, 26b of the first trolley 16. Pinion gears 50a, 50b are rotatably mounted at each end of the opposing edges 48c and 48d. The movable second trolley 40 supports motors (not shown) connected to pinion gears 50a, 50b. Each pinion gear 50a, 50b has teeth 52 which cooperate with teeth 54 on the rack 46 such that when the motor rotates the pinion gear 50a, 50b the pinion travels along the rack which moves the movable second trolley 40 along the supports 26a, 26b of the trolley frame 24 shown as arrows “D” in FIG. 1A. The pinion gears 50a, 50b support the weight of the second trolley 40 and assist in transferring loads or forces acting on second trolley 40 to supports 14a, 14b of the apparatus.

The motor is connected to a control unit (not shown) to allow the accurate movement of the second trolley along the supports 26a, 26b of the trolley frame 24. The control unit is configured to allow remote and/or automated movement of the second trolley.

A rotatable platform 60 is rotatably mounted on or to base 48 of the second trolley 40. The platform 60 is made of steel plate and is received is a cylindrical aperture in the base 48. The rotatable platform 60 is supported by gearing assembly. A drive assembly (not shown) is configured to rotate the platform. The rotatable platform 60 acts as turntable enabling any device or load attached to rotatable platform 60 to rotate about an axis relate to the base 28 and positioning system shown as axis “G” in FIG. 1B. The drive assembly is connected to a control unit (not shown) to allow the accurate rotational movement of the platform 60. The control unit is configured to allow remote and/or automated movement rotational movement of the platform 60.

It will be appreciated that in some embodiments devices or loads may be attached to and supported by the base and/or the platform 60. In other embodiments rotation of a device or load may not be required. In these embodiments the device or load may be attached to the base, the first trolley, the second trolley or any component of the positioning system.

The positioning system provides movement of the base in two different axes. The first trolley 16 is configured to move along a longitudinal axis shown as arrow “C”. The second trolley of second trolley 40 is configured to move along a transverse axis shown as arrow “H”. This provides the positioning system with precision movement and alignment in two axes. This may allow a device or load connected to the base 48 or platform 60 to be located with high accuracy in two axes.

The controlled movement of the first trolley 16 and second trolley 40 independently in two different axes may allow precise and accurate positioning of a device or load connected to the base or platform 60 without requiring movement of the entire positioning system. This may allow fine positioning control with high precision.

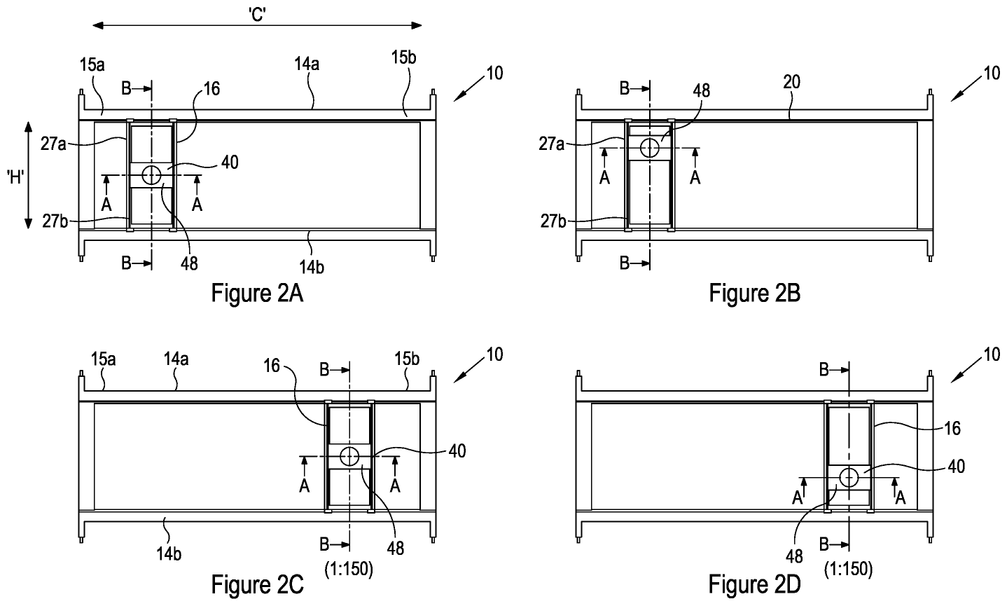

FIG. 2A to 2D show top plan views of the positioning apparatus where the trolley 16 and second trolley 40 are located in various positions. The first trolley 16 is movable to any position along the longitudinal length the support beams 14a, 14b denoted as “C” in FIG. 2A. As an example, in FIG. 1A the first trolley 16 is located at an approximate midpoint of the longitudinal length. In FIGS. 2A and 2B the first trolley 16 is located close to first end 15a of the support beams 14a, 14b. In FIGS. 2C and 2D the first trolley 16 is located close to second end 15b of the support beams 14a, 14b.

The second trolley 40 is movable to any position along the longitudinal length of supports 26a, 26b of the trolley frame 24 denoted as “H” in FIG. 2A. As an example, in FIGS. 2A and 2C the second trolley 40 is located at an approximate midpoint of the longitudinal length. In FIG. 2B the second trolley 40 is located close to a first end 27a of the supports 26a, 26b. In FIG. 2D the second trolley 40 is located close to a second end 27b of the supports 26a, 26b.

The positions shown in FIGS. 2A to 2D are example positions that the first trolley 16 and second trolley 40 of the lift apparatus may be moved to or between. The base 48 has two independently moveable directions along the horizontal X and Y axes. The X-axis may be defined by the longitudinal guide 20 on support beams 14a. 14b. The Y-axis may be defined by the longitudinal guide 42 on the supports 26a, 26b. Depending on the type of load or equipment attached to the base 48 and/or the rotatable platform further independent movement or degrees of freedom may be achieved.

It will be appreciated that the positioning system 10 can adopt different configurations depending on the structure of the lift apparatus on which the positioning system is installed or supported, the type of operation required and/or the equipment or load the positioning system supports.

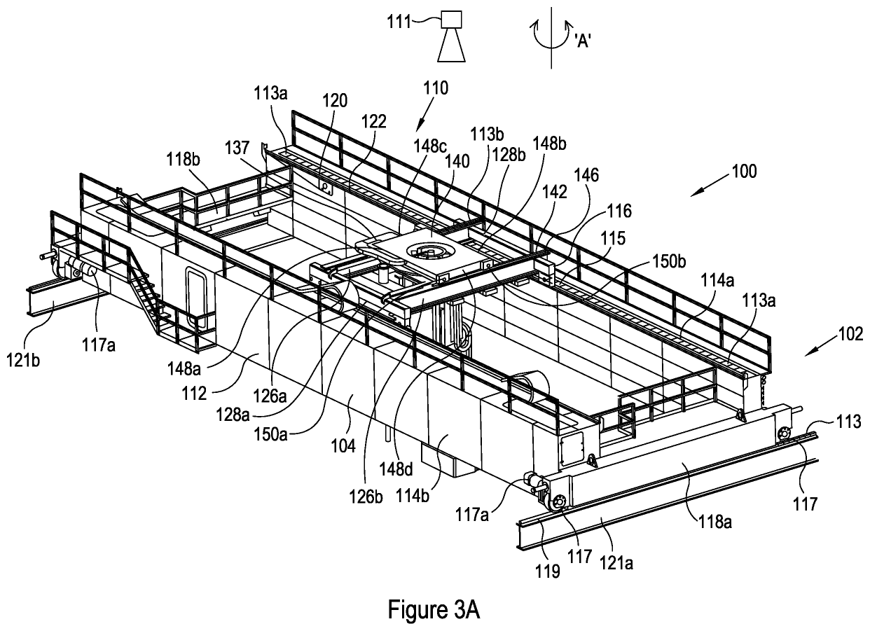

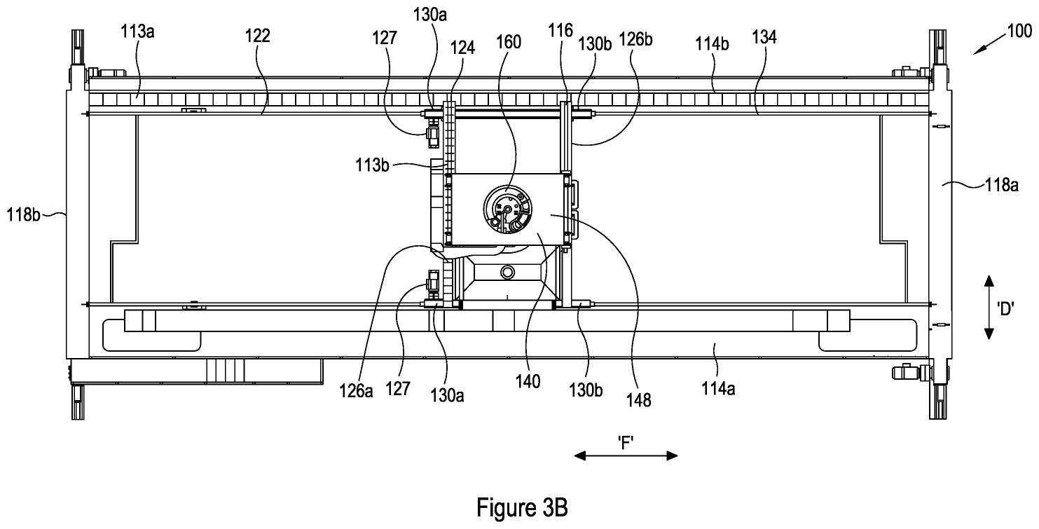

FIGS. 3A and 3B represents a possible configuration where the positioning system 110 is supported on a gantry crane 102. The positioning system 110 is similar to the positioning system 10 described in FIGS. 1A to 2D and will be understood from the description of FIGS. 1A to 2D. However, the positioning system 110 forms a crane bridge and is movably mounted on an overhead crane 100.

The positioning system 110 has a frame 112 comprising two support beams 114a, 114b which are substantially parallel to each other on which a trolley 116 is movably mounted relative to the support beams 114a, 114b.

The overhead crane 102 has two substantially parallel runway beams 121a and 121b on which rails 119 are mounted. The runway beams 121a and 121b support the positioning system 110 to which a piece of equipment or load is attached. In this example the piece of equipment is an anode replacement system. The two support beams 114a, 114b act as crane bridge girders and form a crane bridge 104 which is movably mounted on support rails 119 forming an overhead crane 102.

In this example the runway beams form part of the building structure. However, alternatively the runway beams 121a and 121b may be mounted on supports such as column supports movable in three axes or stationary column supports. The positioning apparatus 110 has cross beams 118a, 118b at each end of the support beams 114a, 114b. Rail wheels 117 are mounted on the cross beams 118a, 118b and are configured to engage the rail 119 on the runway beams 121a and 121b. Actuation of motors 117a move the rail wheels 117 to allow movement of the positioning apparatus along the longitudinal length of the runway beams 121a and 121b. A plurality of QR codes 113 is arranged at known positions along the longitudinal length of the runway beam 121a. A camera system 111 captures image data of the QR codes to accurately locate the position of the positioning apparatus 110 along the longitudinal length of the runway beams 121a and 121b.

The positioning apparatus has a trolley 116 movably mounted relative to the support beams 114a, 114b. The support beams 114a, 114b have a longitudinal guide 120 located on an upper surface 115 of the support beams 114a, 114b. The longitudinal guide 120 spans the longitudinal length of the support beams 114a, 114b. In this example the longitudinal guide 120 is a toothed rack 122. A plurality of QR codes 113a are arranged at known positions along the longitudinal length of the support beams 114a. The camera system 111 captures image data of the QR codes 113a to accurately locate the position of the trolley 116 along the longitudinal length of the support beam 114a.

The trolley 116 has a trolley frame 124 comprising two girder supports 126a, 126b and two drive supports 128a, 128b. The two drive supports 128a, 128b are connected to the supports 126a, 126b as end supports with the drive supports 128a, 128b arranged substantially parallel with the frame support beams 114a, 114b. The two supports 126a, 126b span the distance between the substantially parallel support beams 114a, 114b. The drive supports 128a, 128b have pinion gears 130a, 130b at each end.

The pinion gears 130a, 130b are rotatably mounted on the drive supports 128a, 128b. The trolley frame 124 supports reversible motors 127 best shown in FIG. 3B connected to pinion gears 130a. Each pinion gear 130a, 130b has teeth 132 which cooperate with teeth on the rack 122 such that when the motors 127 rotates the pinion gear 130a the pinions 130a, 130b travel along the rack 122 which moves the trolley 116 along the support beams 114a, 114b shown as arrow “F” in FIG. 3B. The pinion gears 130a, 130b support the weight of the trolley 116 and assist in transferring loads or forces acting on the trolley 116 to the support beams 114a, 114b of the positioning system 110.

The motors 127 are connected to a control unit 514 to allow the accurate movement of the trolley 116 along the support beams 114a, 114b. The control unit is configured to allow remote and/or automated movement and positioning of the trolley to 1 mm accuracy. In this examples the motors are servomotors.

The trolley 116 supports a second trolley 140. Each of the supports 126a, 126b of the trolley frame 124 has a longitudinal guide 142 located on an upper surface of the support beams 126a, 126b. The longitudinal guide 142 spans the longitudinal length of the supports 126a, 126b. In this example the longitudinal guide 142 is a rack 146. The second trolley 140 has a base 148 made of steel plate with edges 148a, 148b, 148c and 148d. A plurality of QR codes 113b is arranged at known positions along the longitudinal length of the support beam 126a. The camera system captures image data of the QR codes 113b to accurately locate the position of the second trolley along the longitudinal length of the support beam 126a of the first trolley 116.

Opposing edges 148a and 148b span the distance between the substantially parallel supports 126a, 126b of the trolley 116. Pinion gears 150a, 150b are rotatably mounted at each end of the opposing edges 148c and 148d. The second trolley 140 supports motors 137 connected to pinion gears 150a. Each pinion gear 150a, 150b has teeth 152 which cooperate with teeth on the rack 146 such that when the motor rotates the pinion gear 150a the pinion travels along the rack which moves the second trolley 140 along the supports 126a, 126b of the trolley frame 124 in a direction shown as arrows “D” in FIG. 3B. The pinion gears 150a, 150b support the weight of the second trolley 140 and assist in transferring loads or forces acting on second trolley 140 to supports 114a, 114b of the apparatus.

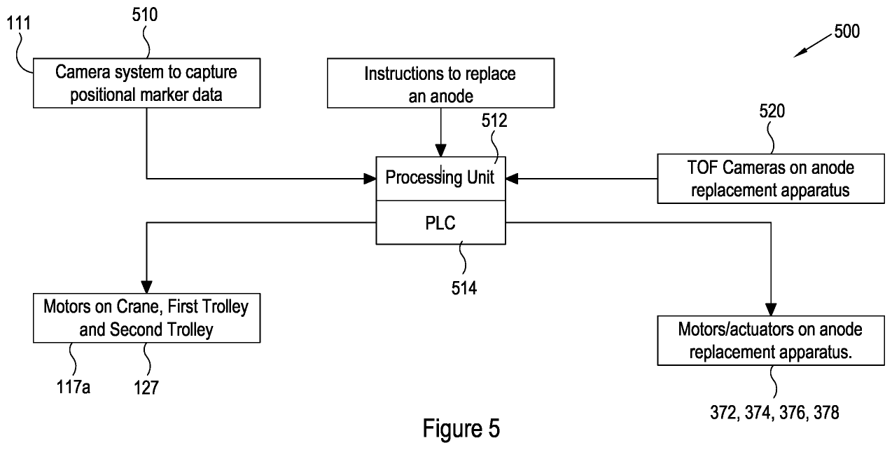

The second trolley motor 137 is connected to a control unit 514 (discussed further in relation to FIG. 5), to allow the accurate movement of the second trolley 140 along the supports 126a, 126b of the trolley frame 124. The control unit is configured to allow remote and/or automated movement of the second trolley.

A rotatable platform 160 is rotatably mounted on base 148 of the second trolley 140. The rotatable platform 160 is supported by gearing assembly. A drive assembly (not shown) is configured to rotate the platform. The drive assembly is connected to the control unit 514 to provide controlled rotational movement of the rotatable platform 160. In this example a load or piece of equipment is attached to the rotatable platform 160. The control unit controls the rotation of the rotatable platform 160 and attached load or piece of equipment in a clockwise or anticlockwise direction relative to the positioning system about rotational axis shown as “A” in FIG. 3A.

The positioning system allows the controlled movement and positioning of a suspended load or device to a first coarse position by moving the positioning system along the rails 119 of the overhead crane 102.

The system also allows fine positional control by moving the first and second trolley in two axes relative to the stationary positioning apparatus 110. By moving the second trolley in a direction substantially parallel to the longitudinal direction of the rails 119, the system allows fine control adjustment of the position of a connected load or device without requiring movement or repositioning of the entire crane 102 or positioning apparatus 110.

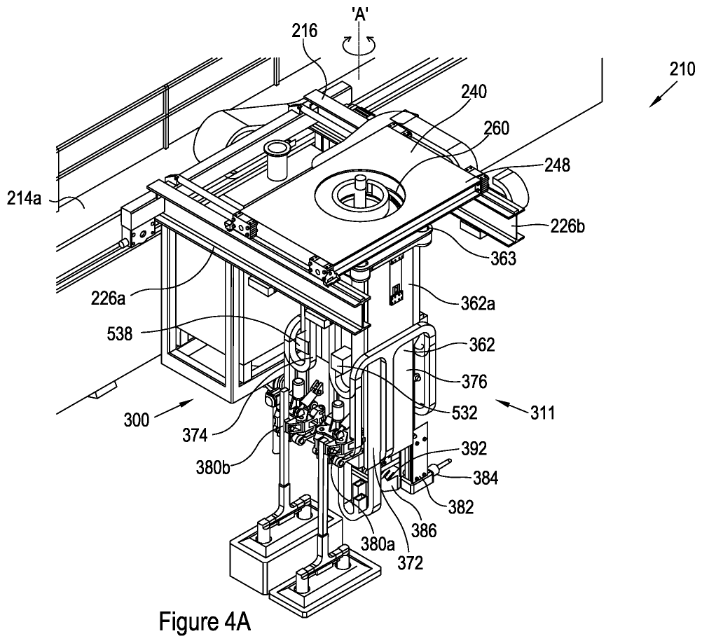

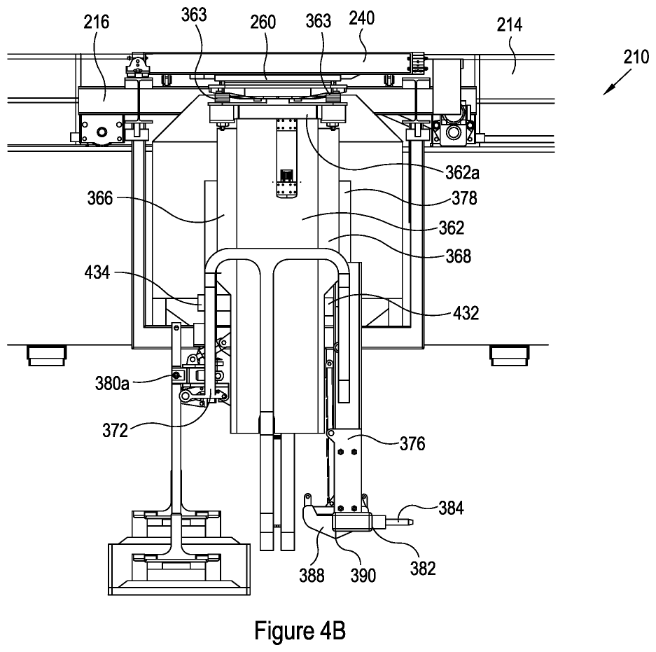

FIGS. 4A and 4B shows an enlarged perspective, side, and front-end views of positioning system 210 connected to a piece of equipment according to an embodiment of the present invention. In this example the piece of equipment is anode replacement equipment 311. In FIGS. 4A and 4B only one support 214a is shown and the first trolley supports 226a, 226b have been truncated for clarity.

The positioning system 210 is similar to the positioning system 110 described in FIGS. 3A and 3B will be understood from the description of FIGS. 3A and 3B. However, the positioning system 210 is connected to and supports a piece of equipment 300. In this example the piece of equipment 300 is an anode replacement system 311 used in the manufacture of aluminium.

Aluminium production plants comprise several hundreds of electrolytic cells also known as pots which are arranged in series into potlines. In electrolytic cell an electrolytic bath containing electrolyte consisting of molten cryolite is used to dissolve alumina during aluminium production. During the electrolytic process oxide ions from the alumina react with a carbon anode block and gradually consumes the carbon anode block forming gaseous carbon dioxide (CO2) in the process. Once consumed the anode is required to be replaced to allow aluminium production to continue. The anode replacement system 311 is used in the removal of an expired anode and replacement of a new anode.

As shown in FIGS. 4A and 4B the anode replacement system 311 is attached to the rotatable platform 260 on the base 248 of the second trolley 240. The anode replacement system 311 has a central frame 362. An upper component 362a of the frame is mounted to a lower surface of the rotatable platform 260 via springs 363. In this example four springs 363 are mounted between the rotatable platform 260 and the upper component 362a, one spring at each corner of the upper component 362a. The springs act as a shock absorber in the event that a shock or impact is exerted on a component of the anode replacement system 311 is it absorbed by the springs 363 and not transmitted to the rotatable platform or components of the trolleys or crane. The frame 362 may be rotated up to approximately 360 degrees about rotational axis shown as “A” in FIGS. 4A and 4B by rotating platform 260.

In this example, the frame 362 supports four telescopic members 370 shown to be in a fully retracted position. Two telescopic members 372, 374 are located side by side on one side 366 of the frame. Two telescopic members 376, 378 are located side by side on a second side 368 of the frame. Each of the four telescopic members supports a functional module. Each of the telescopic members 372, 374 support an anode gripper apparatus 380a, 380b. Each anode gripper apparatus 380a, 380b mounted on telescopic members is capable of gripping and lifting an anode assembly by gripping an anode shaft.

In this example the anode replacement system 311 has two anode gripper apparatus 380. It will be appreciated that in other embodiments the anode replacement system may have one or more anode gripper apparatus.

Telescopic member 376 supports a crust breaker device 382. The crust breaker device has a pneumatic or hydraulic cylinder 384 with a reciprocating shaft which act as a crust breaking chisel or hammer. The chisel or hammer configured to penetrate or impact a crust that forms on an upper surface of the molten electrolyte.

Telescopic member 378 supports a scoop 386. The scoop 386 is dimensioned to have the greater width than the anode. The scoop 386 has sides 388 with a curved base 390 forming a bucket. The curved base has a plurality of apertures 392 or slots dimensioned to retain solid material in the bucket such as crust fragments and solid alumina whilst allowing molten or liquid material to pass through the apertures and remain the bath.

It will be each of the telescopic members 370 is connected to an actuator to move the telescopic members 370 between an extended and a retracted position. In this example a hydraulic actuator is used. It will be appreciated that other actuator types may be used including pneumatic or electric actuators. It will also be appreciated that a combination of actuator types may be use selected from the group comprising hydraulic, electric and pneumatic actuators to control the extension and retraction of the telescopic members and/or the actuation of the functional module such as crust breakers or scoops mounted on the telescopic members.

FIG. 5 shows a schematic of a sensor, processing, and control system to position and control a positioning system and connected anode replacement system 311. FIG. 5 is described in relation to the positioning system as described in FIGS. 3A to 4B and the anode replacement system 311 as described in FIGS. 4A and 4B.

The system 500 has a first camera system 510 configured to capture image data of positional markers located at known positions on the crane, positioning apparatus, the first trolley and the second trolley. In this example the positional markers are QR codes and are located along the longitudinal length of runway beam 121a, support beam 114a and support beam 126a using the camera system 111.

Optionally, components of the pot room including equipment, pots, anodes and/or lids may comprise one or more positional markers such as QR codes to assist in the guidance system accurately positioning the anode replacement system in the pot room or relative to selected pots, anodes and/or pot lids. This may also assist in the guidance system identifying and moving components of the positioning system and/or connected components of an anode replacement system around known obstacles in the workspace.

The system 500 has a processing unit 512 in communication with a programmable logic controller (PLC) 514. The processing unit 512 receives captured QR image data from the camera system 510. The processing unit 512 identifies the QR code as a specific location on the crane, positioning apparatus or the first trolley.

To locate the anode replacement system 311 attached to the second trolley at position adjacent to a specific anode to be replaced, the sensor system 500 locates the positioning apparatus at a desired position on the crane. The processing unit identifies the corresponding QR code associated with the new location on the crane. The PLC 514 controls the motors 117a to move the positioning apparatus along the longitudinal length of runway beam 121a to reach the new location on the runway beam 121a of the crane. Optionally the processing unit uses real time feedback from the first camera system 510 to confirm the positioning apparatus is located at the correct position on the runway beam 121a using captured QR code data.

The system 500 then locates the first trolley at a desired position on the positioning apparatus. The processing unit identifies the corresponding QR code associated with the new location on the positioning apparatus. The PLC controls the motors 127 to move the first trolley along the longitudinal length of support beams 114a, 114b to reach the new location on the support beams 114a, 114b of the positioning apparatus. Optionally the processing unit uses real time feedback from the first camera system 510 to confirm that the first trolley 116 is located at the correct position on the support beam 114a using captured QR code data.

The system 500 then locates the second trolley at a desired position on the first trolley. The processing unit identifies the corresponding QR code associated with the new location on the first trolley. The PLC controls the motors 137 to move the second trolley along the longitudinal length of support beams 126a, 126b to reach the desired location on the support beams 126a, 126b of the first trolley. Optionally the processing unit uses real time feedback from the first camera system 510 to confirm that the second trolley 116 is located at the correct position on the support beam 126a and that the anode replacement system is located adjacent to a desired anode location using captured QR code data.

Although the movement of the positioning system, first trolley and second trolley are described as a sequential movement it will be appreciated that the sequence order may be different. It will also be appreciated that the movement of the positioning system, first trolley and/or second trolley may be simultaneous, synchronised or have overlapping action movements. The system 500 has a vision system 520 configured to accurately obtain accurate positional data on components of the anode replacement system 311 and their surrounding environment.

The vision system comprises four time of flight (TOF) cameras 432, 434, 436, 438 shown in FIGS. 4A and 4B. Each TOF camera is mounted on an individual telescopic member 370. The TOF camera provide real time images and distance information between the camera and the subject for each point of the image. The processing unit 512 receives the positional data to allow the accurate control and movement of the telescopic members and the attached functional module.

Once the sensor system 500 has located the anode replacement system 311 adjacent to an anode to be replaced. The TOF camera 432 mounted on the telescopic member 376 obtains positional data for the crust breaker device 382 relative to the crust surrounding the anode to be replaced. The processing unit uses real time positional data from the TOF camera 432 to issue signals to the PLC to control the extension of the telescopic member 376 and the actuation of the crust breaker device 382 to dislodge and break the crust to free the spent anode.

The PLC controls the rotation of the rotatable platform through approximately 180 degrees. The TOF camera 434 mounted on telescopic member 372 obtains positional data on the position of the first anode gripper apparatus 380a and the adjacent spent anode. The processing unit receives real time positional data from the TOF camera to issue signals to the PLC to control the extension of the telescopic member 372 to bring the first anode gripper apparatus 380a adjacent to the spent anode. The processing unit receives real time positional data from the TOF camera 434 to issue signals to the PLC to actuate the first anode gripper apparatus 380a to grip the spent anode. Once gripped, the PLC controls the retraction of the telescopic member 372 to lift the spent anode out of the bath.

The PLC controls the rotation of the rotatable platform through approximately 180 degrees. The TOF camera 436 obtains positional data on the position of scoop 386 and the electrolytic bath where the anode was removed. The processing unit receives real time positional data from the TOF camera 436 to issue signals to the PLC to control the extension of the telescopic member 378 and to actuate the scoop to remove solid materials from the bath and prevent any obstacles to the positioning of the replacement anode in the bath.

The PLC controls the rotation of the rotatable platform through approximately 180 degrees. The TOF camera 438 mounted on telescopic member 374 obtains positional data on the position of the second anode gripper apparatus 380b and attached replacement anode. The processing unit receives real time positional data from the TOF camera 438 to issue signals to the PLC to control the extension of the telescopic member 374 and fine adjustment of the second anode gripper apparatus 380b to accurately position the attached replacement anode into the bath.

The accurate positioning of the anode replacement system 311 is crucial to ensure that the crust breaker 382 and scoop 386 are positioned and orientated correctly to break and clear crust from an anode to be replaced. It is also important that the anode gripper apparatus 380a are positioned accurately to allow the gripping and lifting of the correct spent anode assembly.

The accurate positioning of the replacement anode is also crucial to maintain the efficiency of the electrolytic process. The anodes in the pot are replaced at different times and therefore are in operation for different durations resulting in a different degree of consumption for each spent anode. The height at which a replacement anode should be suspended may be different for each anode in the pot. The accurate positioning of a replacement anode is crucial to maintain the efficiency of the electrolytic process as the height of each removed spent anode may be different.

The position of the replacement anode and degree of immersion in the electrolytic bath must be adjusted every time such that the height of the lower surface of the replacement carbon anode from the cathode must be the same as the height of the lower surface of the expired carbon anode from the cathode. The lower surface of the replacement carbon anode must also be parallel with the cathode to ensure efficient electrolytic reaction.

In the above example the anode replacement system 311 is described as having an attached replacement anode. However, it will be appreciated that the sensor system may identify a replacement anode storage area. The sensor system may control the movement of the crane, positioning system, first trolley, second trolley and/or the second anode gripper apparatus 380b to collect the replacement anode from the anode storage area.

It will be appreciated that the sensor system may identify a storage area to dispose of the spent anode. The sensor, processing and control system may control the movement of the crane, positioning system, first trolley, second trolley and/or the first anode gripper apparatus 380a to deposit the spent anode into the spent anode storage area.

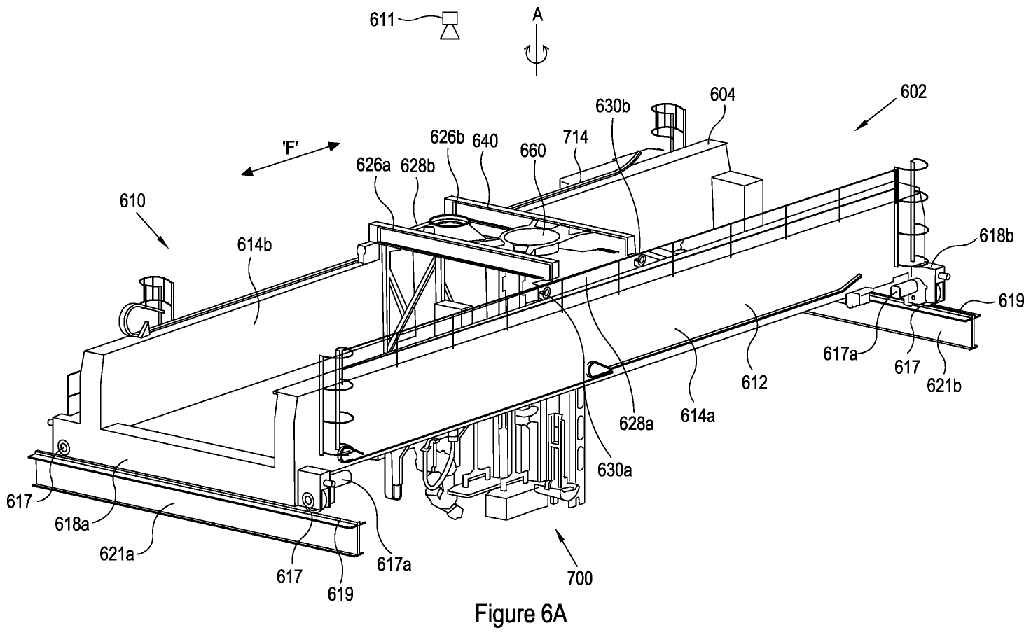

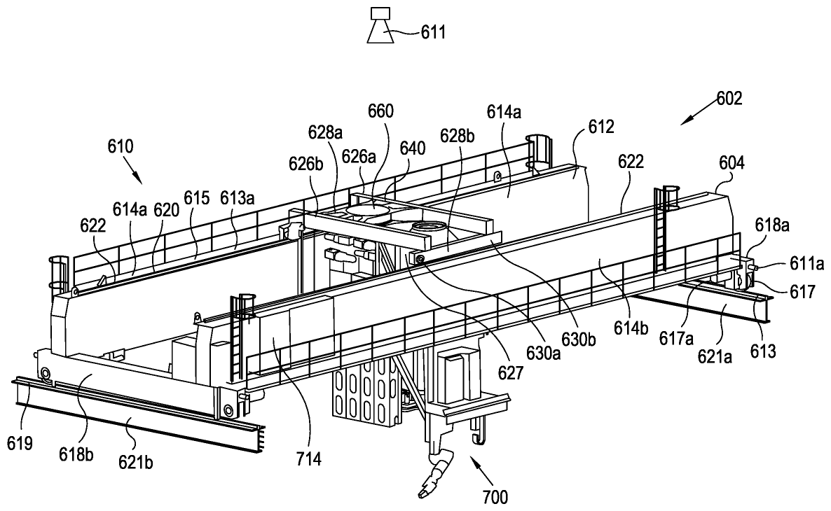

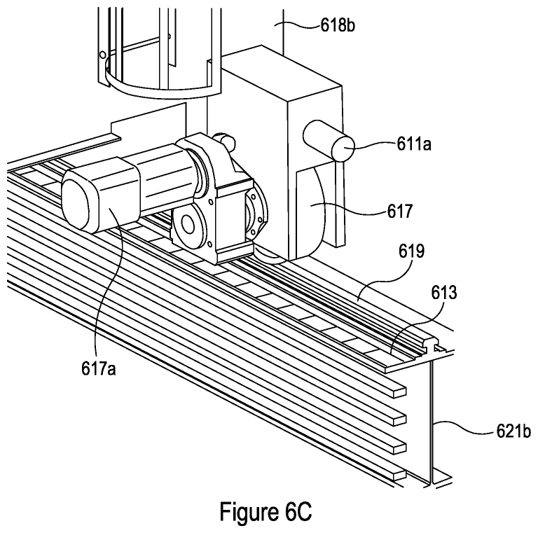

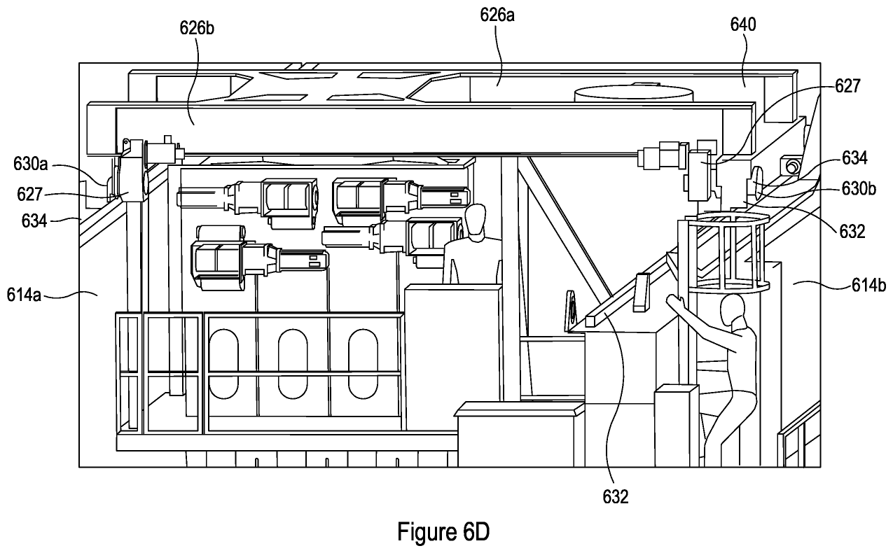

FIG. 6A and FIG. 6B show front and rear perspective views of positioning system 610. The positioning system 610 is similar to the positioning system 110 described in FIGS. 3A and 3B and will be understood from the description of FIGS. 3A and 3B.

However, the anode replacement system is suspended from the first positioning member which in this example is the trolley 640.

The positioning system 610 has a frame support 612 comprising two support beams 614a, 614b which are substantially parallel to each other on which a trolley 640 is movably mounted relative to the support beams 614a, 614b.

The positioning system 610 is movably mounted on two substantially parallel runway beams 621a and 621b on which rails 619 are mounted. The runway beams 621a and 621b support the positioning system 610 to which a piece of equipment or load is attached. In this example an anode replacement system 700 is attached. The two support beams 614a, 614b act as crane bridge girders and form a crane bridge 604 which is movably mounted on support rails 619 forming an overhead crane 602.

In this example the runway beams form part of the building structure. However, alternatively the runway beams 621a and 621b may be mounted on supports such as column supports movable in three axes or stationary column supports. The positioning apparatus 610 has cross beams 618a, 618b at each end of the support beams 614a, 614b. As best shown in FIG. 6C rail wheels 617 are mounted on the cross beams 618a, 618b and are configured to engage the rail 619 on the runway beams 621a and 621b. The rotation of the wheels 617 is controlled by servomotors 617a. Actuation of servomotors 617a move the rail wheels 617 to allow movement of the positioning apparatus along the longitudinal length of the runway beams 621a and 621b with up to +/−0.5 mm accuracy. A plurality of QR codes 613 is arranged at known positions along the longitudinal length of the runway beam 621a. A camera system 611, 611a captures image data of the QR codes to accurately locate the position of the positioning apparatus 610 along the longitudinal length of the runway beams 621a and 621b. In this example a camera 611a is located on the crossbeams 618a, 618b. Alternatively or additional an overhead camera 611 may be used. Feedback from the camera system 611 may control the actuation of the servomotors 617a.

The positioning apparatus has a trolley 640 movably mounted relative to the support beams 614a, 614b. The support beams 614a, 614b have a longitudinal guide 620 located on an upper surface 615 of the support beams 614a, 614b. The longitudinal guide 620 spans the longitudinal length of the support beams 614a, 614b. In this example the longitudinal guide 620 is a toothed rack 622. A plurality of QR codes 613a are arranged at known positions along the longitudinal length of the support beams 614a. The camera system 611 captures image data of the QR codes 613a to accurately locate the position of the trolley 640 along the longitudinal length of the support beam 614a.

The trolley 640 has a trolley frame 624 comprising two girder supports 626a, 626b and two drive supports 628a, 628b. The two drive supports 628a, 628b are connected to the supports 626a, 626b as end supports with the drive supports 628a, 628b arranged substantially parallel with the frame support beams 614a, 614b. The two supports 626a, 626b span the distance between the substantially parallel support beams 614a, 614b. The drive supports 628a, 628b have pinion gears 630a, 630b at each end.

The pinion gears 630a, 630b are rotatably mounted on the drive supports 628a, 628b. The trolley frame 624 supports reversible servomotors 627 best shown in FIG. 6D connected to pinion gears 630a. Each pinion gear 630a, 630b has teeth 632 which cooperate with teeth 634 on the rack 622 such that when the servomotors 627 rotates the pinion gear 630a the pinions 630a, 630b travel along the rack 622 which moves the trolley 616 along the support beams 614a, 614b shown as arrow “F” in FIG. 6A. The pinion gears 630a, 630b support the weight of the trolley 640 and assist in transferring loads or forces acting on the trolley 640 to the support beams 614a, 614b of the positioning system 610.

The servomotors 627 are connected to a control unit 714 to allow the accurate movement of the trolley 640 along the support beams 614a, 614b. The control unit is configured to allow remote and/or automated movement and positioning of the trolley up to +/−0.5 mm accuracy.

A rotatable platform 660 is rotatably mounted on base 648 of the trolley 640. The rotatable platform 660 is supported by gearing assembly. A drive assembly (not shown) is configured to rotate the platform. The drive assembly is connected to the control unit 714 to provide controlled rotational movement of the rotatable platform 660. In this example an anode replacement system 700 is attached to the rotatable platform 660. The control unit controls the rotation of the rotatable platform 660 and the anode replacement system 700 in a clockwise or anticlockwise direction relative to the positioning system about rotational axis shown as “A” in FIG. 6A.

The positioning system allows the controlled movement and positioning of the anode replacement system 700 by actuating the servomotors 617a, 627 to move the crane bridge 604 and/or trolley 640 to a desired position with millimetre precision.

In the above examples the vision system uses QR codes to accurately position the crane and trolleys. However, it will be appreciated that alternative positional markers may be used including data matrix codes, bar codes, coloured markings and/or tapes.

In the above examples the positional markers are described as being located on one support beam. It will be appreciated that corresponding positional markers may be located on multiple support beams or on multiple surfaces of support beams to provide redundancy in the event that one or more positional markers a support beam surface become obscured with dirt or damaged. It will be appreciated that positional markers may be located on components on the anode replacement system such as the telescopic members. This may allow accurate positional control over the extension/retraction of the telescopic members. In the above examples the camera system for detecting the positional markers is described as being above the crane. It will be appreciated that different sensor types may be used capable of detecting the positional markers. It will be appreciated that the at least one sensor may be mounted or positioned on components of the positioning system such as the support, first trolley or second trolley. The at least one sensor may be located or mounted on a component of the crane or vehicle supporting the positioning system. The at least one sensor may be located or mounted on a component of a surrounding structure such as a floor, walls and/or roof.

It will be appreciated that the positioning system can support a range of payloads and equipment depending on the application.

The invention may allow the precise controlled movement of a payload or piece of equipment and mitigate the requirement to reposition a supporting crane or vehicle thereby saving time and costs. The ability to provide controlled movement of a payload or piece of equipment using a positioning system rather than moving a bulky crane or vehicle may mitigate the risk to personnel or infrastructure. If the crane is operated by a crane operator, they may not have good visibility of the work environment, obstacles in the work environment or the movement path of the crane.

By providing a positioning system capable of controlled movement of a payload or piece of equipment rapidly with a high degree of accuracy may increase the efficiency of an industrial plant.

As an example, in an aluminium production plant the anodes may be replaced using the present invention quickly with a higher degree of precision. An anode replacement apparatus may be suspended on a trolley in the positioning system which is mounted on a crane. The bulky crane may be moved in a first direction to quickly locate the anode replacement apparatus to a first degree of positional accuracy relative to the pot. Because the crane is not required to locate the anode replacement apparatus in its final position this can be a rapid and coarse positioning movement. A trolley in the positioning apparatus may be moved in a direction parallel to the first direction to locate the anode replacement apparatus to a second degree of positional accuracy relative to the pot. The second degree of positional accuracy may be higher than the first degree of positional accuracy to accurately locate the anode replacement apparatus in a correct position. The anode replacement apparatus may also be repositioned by moving a trolley on the positioning system without requiring the movement of the bulky crane.

It is important that the anode replacement operation is performed as quickly as possible. The operation requires that pot lids which assist in confining toxic gases within the pot are temporarily removed allowing the gases to enter the pot room which is hazardous. Reducing the time that the pot lid is removed from the pot reduces heat loss from the electrolytic bath which may mitigate a reduction in the efficiency of the electrolytic process. The ability to quickly position a support crane and use the first trolley and second trolley to accurately and quickly move between different operations such as crust breaking, scooping crust debris from the electrolytic bath, anode removal and anode replacement operations without moving the bulky crane may speed up the operation and reduce the time that the pot lids are removed from the pots reducing the emissions of toxic gases released into the potroom.

The present invention in its various aspects provides an improved system and method for quickly and accurately lifting and/or moving a load or piece of equipment. The system may allow automated positioning, movement, extension, retraction and/or orientation of a load or equipment. The system may allow automated controlled connection, lifting, movement and/or release of a payload. The system may allow automated controlled positioning and movement of equipment to perform a number of automated operations or tasks. The system and method may mitigate the need for on-site workers manually connecting a load or operating equipment.

The ability to accurately control the positioning of equipment and minimise the movement of bulky cranes in the work environment mitigates the degree of human interaction with the apparatus and therefore the dangers to personnel from the movement of bulky heavy apparatus. The automated control and positioning of the apparatus also mitigate the risk of collisions with infrastructure and reduces the risk of human error in a dangerous environment.

The system may be a semi-automated system where a crane operator operates the crane to move the general location of the pot. As the crane is not required to be in an accurate position relative to the pot this may be done quickly and safely. The crane operator is not preoccupied with locating the crane precisely at a particular anode location and is able to concentrate on potential obstacles in the crane movement path. Once the crane is in position the automated control system may use sensor feedback to move the anode replacement system mounted on a positional member such as a trolley to the correct accurate position. The ability to control the positioning of equipment using an automated system mitigates the dangers to personnel.

The invention provides a positioning system for a lifting apparatus. The positioning system comprises a support having a longitudinal axis. The system comprises a first positioning member movably mounted to the support, wherein the first positioning member comprises a first axis and a second axis and is configured to move along the longitudinal axis of the support with the first axis parallel to the longitudinal axis of the support. The system also comprises a second positioning member mounted to the first positioning member and configured to move transversely to the first axis of the first positioning member.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. A positioning system for an anode replacement system; the positioning system comprising:
a movable support having a longitudinal axis;
a first positioning member movably mounted to the support, wherein the first positioning member comprises a first axis and a second axis, and is configured to move along the longitudinal axis of the support with the first axis parallel to the longitudinal axis of the support;
a second positioning member mounted to the first positioning member and configured to move transversely to the first axis of the first positioning member;
wherein the anode replacement system is connected to the first positioning member or the second positioning member.

2. The positioning system according to claim 1 wherein the second positioning member is configured to move substantially perpendicularly to the first axis of the first positioning member, which is the second axis of the first positioning member.

3. The positioning system according to claim 1 wherein the first positioning member is configured to be moved along the longitudinal axis of the support by one or more mechanisms configured to slide, push and/or pull the first positioning member and wherein the second position member is configured to be moved transversely to the first axis of the first positioning member by one or more mechanisms configured to slide, push and/or pull the second positioning member.

4. The positioning system according to claim 1 wherein the first positioning member is a first trolley and the second positioning member is a second trolley.

5. The positioning system according to claim 1 comprising at least one drive mechanism comprising one or more motors configured to move the support, first positioning member and/or second positioning member.

6. The positioning system according to claim 5 wherein the one or more motors is a servomotor.

7. The positioning system according to claim 1 wherein the support is configured to move rapidly in a horizontal and/or vertical plane to locate the first positioning member and the second positioning member at a desired location.

8. The positioning system according to claim 1 wherein the support, first positioning member and/or a second positioning member comprise a plurality of positional markers.

9. The positioning system according to claim 8 wherein the plurality of positional markers is selected from the group comprising: barcodes, data matrix codes, quick response codes and/or colour codes.

10. The positioning system according to claim 1 comprising a sensor system, wherein the sensor system comprises at least one sensor selected from the group comprising: optical sensor, camera, vision system, time of flight camera, depth sensor, distance sensor, laser, ultrasound, momentum sensor, accelerometer, rotary position sensors, gyroscopic position sensor, global positioning sensor, infra-red sensor, thermal sensor, load cell and/or LIDAR.

11. The positioning system according to claim 10 wherein the sensor system is configured to detect at least one of the plurality of positional markers to accurately locate and/or move the position of the support, first positioning member and/or a second positioning member.

12. The positioning system according to claim 1 wherein the support, first positioning member and/or the second positioning member is configured to support at least a component of the anode replacement system.

13. The positioning system according to claim 10 wherein the support, first positioning member and/or the second positioning member comprises a rotatable platform configured to suspend and/or support at least a component of the anode replacement system.

14. The positioning system according to claim 13 wherein the support, first positioning member, second positioning member and/or rotatable platform comprises a spring suspension system.

15. The positioning system according to claim 10 wherein the sensor system comprises a vision system configured to obtain accurate positional data on a suspended or supported load and/or a suspended or supported piece of equipment.

16. The positioning system according to claim 15 wherein the vision system comprises at least one optical sensor.

17. The positioning system according to claim 10 wherein the sensor system is configured to generate 3D position information of a piece of equipment in relation to a work environment.

18. The positioning system according to claim 1 wherein the support is a component of a crane or vehicle.

19. The positioning system according to claim 1 wherein the system is an automated system or a semi-automated system.

20. A lifting apparatus, crane or vehicle comprising the positioning system according to claim 1.

21. A method of positioning an anode replacement system, the method comprising providing a positioning system, the positioning system comprising:
a movable support configured to be mounted on a crane or vehicle, the support having a longitudinal axis;
a first positioning member movably mounted to the support, wherein the first positioning member comprises a first axis and a second axis;
a second positioning member connected to an anode replacement system;
the second positioning member movably mounted to the first positioning member;
moving the first positioning member along the longitudinal axis of the support with the first axis parallel to the longitudinal axis of the support; and
moving the second positioning member transversely to the first axis of the first positioning member.

22. The method according to claim 21 comprising detecting at least one positional marker on the crane or vehicle to accurately locate and/or move the position of positioning system.

23. The method according to claim 21 comprising detecting at least one positional marker on the support to accurately locate and/or move the position of first positioning member.

24. The method according to claim 21 comprising detecting at least one positional marker on the first positioning member to accurately locate and/or move the position of second positioning member.

25. The method according to claim 21 comprising moving the positioning system in a direction substantially parallel with the second axis to a first position accuracy and moving the second positioning member in a direction substantially parallel with the second axis to locate the load or piece of equipment to a second position accuracy wherein the second position accuracy is higher than the first position accuracy.

26. The method according to claim 21 comprising obtaining accurate positional data of a suspended load and/or a suspended piece of equipment using the sensor system.

27. A method of replacing an anode in an aluminium production process;
the method comprising:
providing an anode replacement system comprising at least one anode gripping apparatus; and
a positioning system for the anode replacement system;
the positioning system comprising;
a movable support; the support having a longitudinal axis;
a first positioning member movably mounted to the support, wherein the first positioning member comprises a first axis and a second axis;
a second positioning member connected to the anode replacement system;
the second positioning member movably mounted to the first positioning member;
moving the first positioning member along the longitudinal axis of the support with the first axis parallel to the longitudinal axis of the support and/or moving the second positioning member to locate the anode replacement system to replace at least one anode of an electrolytic cell.
